(19) United States
(12) Patent Application Publication
(10) Pub. No.: US 2004/0255336 A1
(43) Pub. Date: Dec. 16, 2004

(54) Methods and apparatus for simultaneous program viewing

(75) Inventors: James D. Logan, Candia, NH (US); Dana Burd, Charlestown, MA (US)

Correspondence Address: CHARLES G. CALL, 68 HORSE POND ROAD, WEST YARMOUTH, MA, 02673-2516, US

(73) Assignee: Gotuit Video, Inc.

(21) Appl. No.: 10/767,946

(22) Filed: Jan. 29, 2004

Related U.S. Application Data
(63) Continuation-in-part of application No. 10/060,001, filed on Jan. 29, 2002.
(63) Continuation-in-part of application No. 09/536,696, filed on Mar. 28, 2000, now Pat. No. 6,576,266.
(63) Continuation-in-part of application No. 10/165,587, filed on Jun. 8, 2002.
(63) Continuation-in-part of application No. 09/536,969, filed on Mar. 28, 2000.
(60) Provisional application No. 60/443,377, filed on Jan. 29, 2003.
(60) Provisional application No. 60/443,379, filed on Jan. 29, 2003.
(60) Provisional application No. 60/264,868, filed on Jan. 29, 2001.
(60) Provisional application No. 60/304,570, filed on Jul. 11, 2001.
(60) Provisional application No. 60/336,602, filed on Dec. 3, 2001.
(60) Provisional application No. 60/297,204, filed on Jun. 8, 2001.
(60) Provisional application No. 60/352,788, filed on Nov. 28, 2001.
(60) Provisional application No. 60/304,570, filed on Jul. 11, 2001.
(60) Provisional application No. 60/336,602, filed on Dec. 3, 2001.

(30) Foreign Application Priority Data
Mar. 30, 1999 (CH) 598/99

(51) Int. Cl. H04N 7/173; G06F 13/00; H04N 5/445; G06F 3/00; H04N 7/16

(52) U.S. Cl. 725/135; 725/136; 725/86; 725/38

(57) ABSTRACT

Methods and apparatus for making two or more different video programs, such as live sports or news programs, available for viewing at the same time. At any given time, the viewer may actually be watching only one of, some of, or all of these programs, but has the ability to switch attention from program to program, without missing the content of any of the programs. This is accomplished by placing all of the program streams in storage, and allowing the viewer to selectively watch one program while suspending the playback of the others. The user can select any of these program streams to watch, and can pause, replay, jump forward and backward in time to any desired portion of the selected program stream.

### CROSS REFERENCE TO RELATED APPLICATIONS

This application is a non-provisional of and claims the benefit of the filing date of U.S. Provisional Patent Application Ser. No. 60/443,377 filed on Jan. 29, 2003.

This application is also a non-provisional of and claims the benefit of the filing date of U.S. Provisional Patent Application Ser. No. 60/443,379 filed on Jan. 29, 2003.

This application is also a continuation in part of and claims the benefit of the effective filing date of U.S. patent application Ser. No. 10/060,001 filed Jan. 29, 2002 published as U.S. Application Publication No. 2002-0120925 on Aug. 29, 2002 which was a non-provisional of Provisional U.S. Patent Application Ser. No. 60/264,868 filed Jan. 29, 2001; a non-provisional of Provisional U.S. Patent Application Ser. No. 60,304,570 filed Jul. 11, 2001; a non-provisional of Provisional U.S. Patent Application Ser. No. 60/336,602 filed Dec. 3, 2001; and a continuation in part of U.S. patent application Ser. No. 09/536,696 filed Mar. 18, 2000.

This application is also a continuation in part of and claims the benefit of the effective filing date of U.S. patent application Ser. No. 10/165,587 filed on Jun. 8, 2002 published as U.S. Application Publication No. 2003/0093790 on May 15, 2003, which was a non-provisional of Provisional U.S. Patent Application Ser. No. 60/297,204 filed Jun. 8, 2001; a non-provisional of Provisional U.S. Patent Application Ser. No. 60/352,788 filed Nov. 28, 2001; a non-provisional of Provisional U.S. Patent Application Ser. No. 60/304,570 filed Jul. 11, 2001; a non-provisional of Provisional U.S. Patent Application Ser. No. 60/336,602 filed Dec. 3, 2001; and a continuation in part of U.S. patent application Ser. No. 09/536,969 filed March 18, 2000.

This application incorporates by reference the disclosure of each of the above-identified applications.

### FIELD OF THE INVENTION

This invention relates to audio and video program reception, storage, editing, recording and playback systems and more particularly to systems for rendering two or more different media programs at the same time using program selection, navigation and display mechanisms controlled in part by metadata.

### BACKGROUND AND SUMMARY OF THE INVENTION

The present invention, called Simultaneous Program Viewing (“SPV”), comprises a set of techniques that enable a viewer to simultaneously view, in an intelligent fashion, multiple channels or “streams” of video content, which may include time-sensitive “live” programs, such as different sports or news broadcasts, produced concurrently on different broadcast, cable or satellite channels.

As used here, the term “simultaneous viewing” should be understood to refer to making two or more different programs available for viewing at the same time. At any given time, the viewer may actually be watching only one of, some of, or all of these programs, but has the ability to switch attention from program to program, without missing the content of any of the programs. This is accomplished by placing all of the program streams in storage, and allowing the viewer to selectively watch one program while suspending the playback of the others. The user can select any of these program streams to watch, and can pause, replay, jump forward and backward in time to any desired portion of the selected program stream.

It should be further understood that, as used herein, the term “video” and “video programs” normally refers to the combination of a video program image and its associated audio content, in the form typically presented by video systems such as broadcast, cable and satellite television systems.

As an example of the need for SPV, on election night a viewer may wish to monitor, and consume every detail of, the live broadcasts put out by all four networks. Today, this is done in an ad-hoc manner by channel surfing during slow points and ads. Using the invention, the user can watch any of the four channels while the other three are placed in storage to await the attention of the viewer. The viewer can skip over any portions of a selected program that are not of interest, and can return to and replay any desired portion of the previously stored program that the view desires to see again. When the viewer switches from the one channel to start watching another, the system pauses the discontinued channel so that, when the viewer returns to it, the playback will be resumed at the point where it was discontinued. If the viewing is interrupted to answer an incoming telephone call or attend to something else, all of the channels can be paused at the same time. The Simultaneous Program Viewing system contemplated by the invention provides a number of features which make watching several programs at once easier and more enjoyable.

First, “segment guide” information is displayed on the screen to assist the viewer in the time-wise navigation of a selected channel. Text metadata which describes the individual segments within the selected stored video stream can be displayed to enable the viewer to jump directly to described events or highlights. The viewer can scan the content forward or backward by jumping from segment to segment, or from highlight to highlight. The viewer can display a mosaic of smaller images that acts as a segment guide, each showing a reduced size image of the content of a stored segment, making it easier for the viewer to quickly identify and view desired segments.

Secondly, information is displayed on the screen which assists the viewer in selecting which channel or channels to actively view at any time. Graphical representations of the available inactive channels can be highlighted and selected using a user-operated control to begin viewing another channel. The displayed information concerning each available inactive channel can include a channel or program identification, a reduced-size image of the visual content from that channel, and/or information that alerts the viewer to events that have occurred on that channel.

In its preferred form, the present invention provides methods and apparatus for simultaneously viewing two or more different video programs. The media content data for the programs is stored in an addressable video memory. Selected portions of the media content data are fetched and displayed either automatically or at the request of the viewer. In addition, program description metadata which identifies and describes each of video programs, and segment description metadata which identifies and describes individual segments of each of the video programs, is created and stored in addressable digital storage. To facilitate the simultaneous viewing of different programs, a composite image is displayed on the television screen that is derived from said media content data, the program description metadata, and the segment description metadata. The composite image consists of a content zone for displaying a video image from a currently displayed segment of a first of the video programs, a program guide zone for displaying a set of program descriptors each of which identifies an individual one of the different video programs, and a segment guide zone comprising a set of segment descriptors each of which identifies an individual segment of the program currently being watched.

A user interface device, typically a hand-held remote control, is used to accept selection commands from the viewer. These selection commands include a segment selection command by which the user designates a selected segment identified by one of said segment descriptors. The system responds to a segment selection command by displaying the selected segment as the currently displayed segment in the content zone of the composite image. A program selection command from the user designating a selected program identified by one of the displayed program identifiers causes one of the segments of the selected program to be displayed in the content zone.

Each of the program descriptors in the program guide zone may take the form of a reduced size image extracted from the media content data for one of said video programs. Alternatively, the program descriptors may take the form of a text label or a graphical symbol which identifies one of the programs which is available for viewing in the simultaneous viewing session.

Each of said segment descriptors in said program guide zone may also be are reduced size image extracted from an individual segment, or may be a text label that describes the segment.

Text labels and other text or graphically descriptive information displayed in the composite image is derived from the program and segment description metadata which may, in the case of live programming, be generated after the video content is created during a televised event, but before the content video data is fetched from digital storage for presentation to the user. Video storage used to time-shift the video presentation for later presentation, and to pause other programs while a selected one is being viewed, may be implemented by PVR units at the subscribers location, or by nPVR units in the media provider's network.

These and other features of the invention are more fully described in the following detailed description of illustrative embodiments of the invention.

### BRIEF DESCRIPTION OF THE DRAWINGS

FIG. 1 is a block diagram illustrating the principle instrumentalities that are used in an illustrative embodiment of the invention as used in cable television delivery system;

FIG. 2 is a block diagram of the mechanism used to concurrently provide multiple, time-shifted programs to a viewer using network personal video records (nPVRs);

FIG. 3 is a block diagram of a mechanism used to concurrently provide multiple, time-shifted programs to a view using digital video storage at the viewer's location to receive and store content and metadata from a satellite television system; and

FIG. 4 depicts a composite image of the kind that may be displayed to the user to provide metadata-based program guide and segment guide indexes to the video content available to the user on demand during the Simultaneous Program Viewing session.

### DETAILED DESCRIPTION

Hardware Architecture

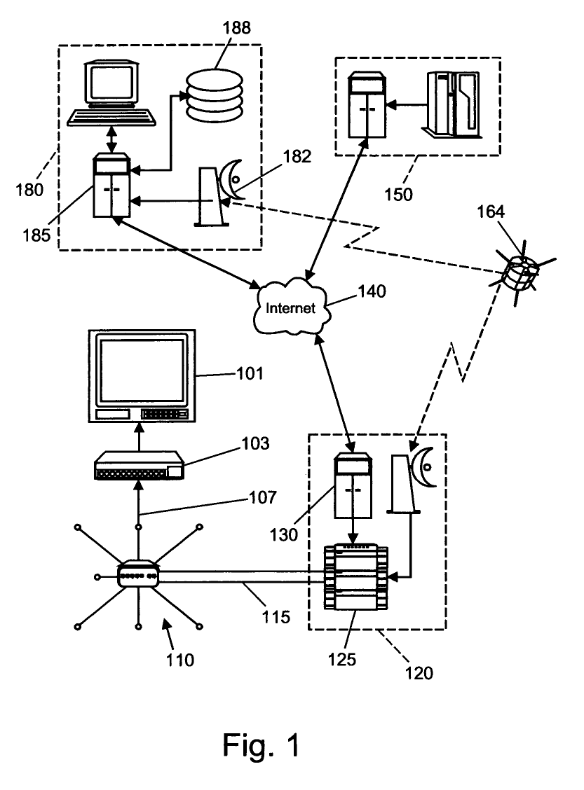

The present invention may be implemented in a variety of environments, one of which is illustrated in FIG. 1 of the drawings. In that embodiment, a user typically watches video programming provided by a cable television system which provides Video on Demand (VOD) programming. A conventional television set 101 is located on the viewer's premises and receives programming via a connected “set top box” 103 that is in turn connected to cable system's facilities by a subscriber cable 107 connected to a hub 110 which includes one or more edge servers that distribute programming to individual subscribers from the “headend” facility 120. The set top box 103 is conventional and receives commands from a hand-held “remote control” device including a keypad that enables the user to navigate and make selections from menu choices or graphical elements displayed on the television set 101. The set top box 103 may also include a built-in digital video recorder which includes a hard disk memory that permits the user to locally store programs, including movies, received via the connected cable system. This locally stored content may be used alone, or in combination with storage available on the network that acts as a “networked personal video recorder” (nPVR). In addition, the user may employ a separate personal video recorder, such as those marketed by TiVo and ReplayTV. These PVR and nPVR units allow the user to pause, rewind and replay live program content as described in U.S. Reissue Pat. No. Re36,801 issued on Aug. 8, 2000 to James D. Logan et al. entitled “Time delayed digital video system using concurrent recording and playback, a reissue of U.S. Pat. No. 5,371,551 issued on Dec. 6, 1994. The nPVR functions are typically provided as part of the cable vendor's VOD service which allow the user to watch programs selected from a catalog of currently available VOD offerings.

Video servers, PVRs and nPVRs use addressable digital memory devices typically consisting of a combination of dynamic RAM storage for short term, high speed storage and processing of video image data and the associated audio, and high-capacity memory devices such as hard disk or flash memory devices for longer term storage.

In the illustrative embodiment of FIG. 1, the edge server(s) in the hub 110 receive MPEG-2 video over an IP/Gigabit Ethernet link 115 from a regional headend 120 which includes a video server farm 125. The edge servers at the hub 110 remove the Ethernet and IP headers, process and route the MPEG-2 video packets to the appropriate output, and QAM modulate and up-convert the signals for transmission over the subscriber cable 107 to the set top box 103. The downstream RF subscriber line connection between the hub 110 and the individual subscribers delivers content from the headend to the set-top box. This content includes video assets (programming), VOD catalog information, and other control information used by the VOD system. To efficiently provide VOD services to the subscriber, the provider may employ a hybrid architecture, locating VOD servers at both the headend and at the hubs. For example, an operator may choose to house a server with the ‘top hits’ at the hubs as well and use the headend server farm 125 to store the “deep library”. To provide VOD services comparable to those offered by an interactive cable system, satellite providers typically rely on local storage devices (hard disk storage units built into the set top box) to store media content which is broadcast to and saved by the set top box in advance of being viewed by the user.

The video storage provided in the set top box, at the hub 110, or at the headend 120 may be used to provide “trick play” functions which vary the playback point of the stored programming (pause, rewind, fast forward, reverse or forward slow motion, or jumping to a designated location). These trick play functions, in combination, with the “segment guide” metadata which delimits, bookmarks and describes the sequence of program segments which make up the stored stream, allow the viewer to easily and accurately navigate each program stream in time to view desired programming.

One or more processors, such as the processor 130 seen in FIG. 1, are located at the cable headend 120 to perform content and business management functions. By way of example, the “OpenStream™ Complete VOD Solution” offered by N2 Broadband provides asset distribution and management, as well as business management, functions needed to implement VOD services. The asset distribution functions supervise the acquisition of content (media assets) which the headend receives by multicasting over satellite or via the Internet. The content is delivered to the headend's “catcher” which serves as temporary storage for assets before they are transferred to the video server farm 125. For example, the headend 120 may receive content via the Internet 140 from a content provider indicated generally at 160, or may receive live broadcast video streams from a satellite 162 using the receiving antenna 164.

When the user is employing the invention to simultaneously monitor programming on different channels (streams), “segment guide” information created by a metadata supplier 180 is transferred, typically while live programs are in process, for distribution with the program content from the headend 120. Metadata of this kind is produced by Gotuit Media Corporation, 300 Brickstone Square, Andover, Mass. 01810 using techniques described in the following patents and published patent applications, the disclosures of which are incorporated herein by reference:

U.S. Pat. No. 5,892,536 issued on Apr. 6, 1999 to James D. Logan et al. entitled “Systems and Methods for Computer Enhanced Broadcast Monitoring”;

U.S. Pat. No. 5,986,692 issued on Nov. 16, 1999 to James D. Logan et al. Entitled “Systems and Methods for Computer Enhanced Broadcast Monitoring”;

U.S. patent application Ser. No. 10/060,001 filed on Jan. 29, 2002 by James D. Logan et al. entitled “Audio and Video Program Recording, Editing and Playback Systems Using Metadata” published as U.S. Application Publication No. 2002-0120925 on Aug. 29, 2002; and

U.S. patent application Ser. No. 10/165,587 filed on Jun. 8, 2002 by James D. Logan et al entitled “Audio and Video Program Recording, Editing and Playback Systems using Metadata” published as U.S. Application Publication No. 2003/0093790 on May 15, 2003.

Metadata produced at by the metadata supplier 180 subdivides program content into segments and describes those segments in various ways. The headend 120 employs the metadata received from the supplier 180 to describe the individual segments within the stored video streams selected by the user for simultaneous program viewing. This metadata includes segment description information that can be displayed to enable the viewer to jump directly to described events or highlights. The viewer scan the content forward or backward by jumping from segment to segment, or from highlight to highlight. The viewer can display a mosaic of smaller images that acts as a segment guide, each showing a reduced size image of the content of a stored segment, making it easier for the viewer to quickly identify and view desired segments.

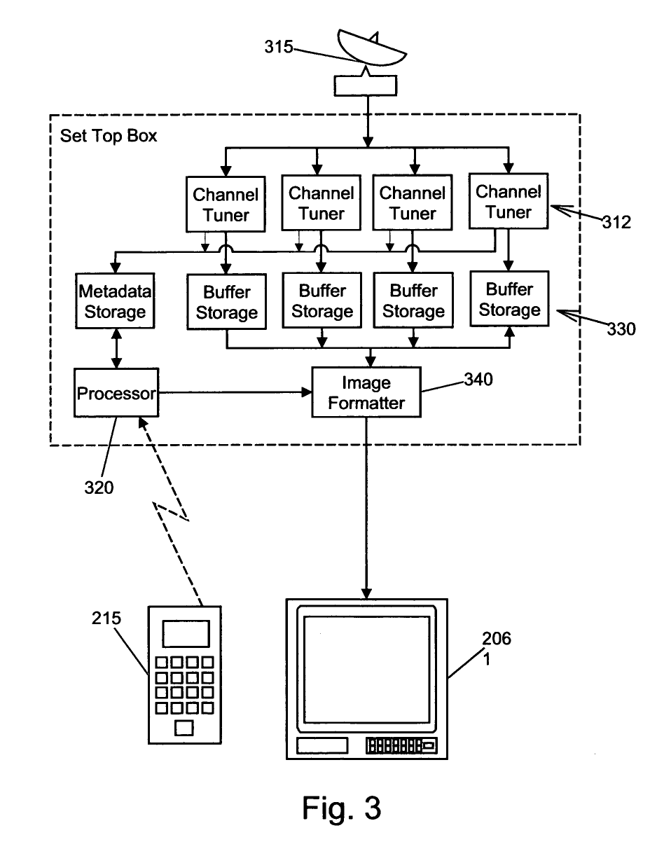

The metadata supplier monitors the same live broadcast content that is being transferred from the headend 120 to the subscriber's television set 101. By way of example, as shown in FIG. 1, the metadata supplier may receive content from the satellite 164 via antenna 182. The received content is reviewed at an editing station by a human editor, by automated segmentation and content extraction routines performed by the processor 185, or by a combination thereof as described in the above noted patents and applications. The resulting metadata is stored in a metadata database 188 and distributed to the headend 120 via the Internet 140. For live programming, the process of creating metadata is performed in real time by the supplier 188 and sent immediately to the headend 120 where it is available to the viewer of programming which has been at least briefly delayed (time shifted) by temporary storage in the video servers at the headend 120 or the hub 110. As will described later in connection with FIG. 3, this metadata may also be used to navigate time shifted programming stored locally at the subscriber's premises in a the digital storage devices provided by a set top box or a standalone Personal Video Recorder (PVR).

The asset manager functions at the headend 120 perform any processing required to modify the provided metadata as needed for the video server(s), and stores, displays and, if necessary, edits the metadata used to describe the received assets. The headend processor 130 further performs business management functions, providing a link between the MSO's subscriber billing system and the VOD system. The headend processor 130 accordingly manages any special billing functions which are appropriate to charge subscribers for presentations which utilize simultaneous viewing capabilities.

Although, for purposes of explanation, the metadata supplier 180 is described as a separate entity, it should be understood that the functions it provides can be performed and/or controlled by a content provider such as the provider 150, a broadcaster which supplies live programs via the satellite 164, by a media distributor such as the VOD provider operating the headend 120, or some combination of these entities. Moreover, although the metadata creation and supply functions, the content provision functions, and the cable headend processing functions are shown as being performed by different processors at different locations, these functions may be performed at the same location by the same or different processors.

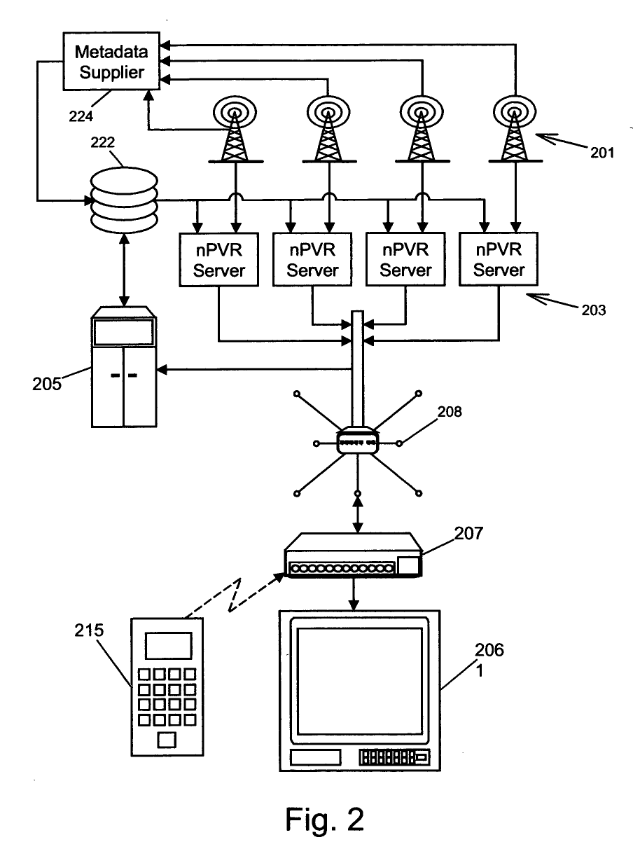

FIG. 2 shows an illustrative mechanism used to concurrently provide multiple, time-shifted programs to a viewer using network personal video records (nPVRs) located at the headend of a cable network facility. In the illustrative example, each of four separately broadcast programs occurring at the same time (as illustrated by the four broadcast sources 201) is received and stored by a corresponding one of four nPVR units indicated generally at 203. The four nPVR devices are each controlled by a single connected processor 205. As will be understood, the nPVRs may all use the same physical storage device or devices which operate under the control of the processor 2055 to store the content received from the sources 20. Each nPVR 203 writes the incoming program continuously to storage and reads the stored data as needed to satisfy playback requests from a user (cable service subscriber) who watches a video presentation on a television set 207. The television 207 is coupled to the nPVRs 203 by a set top box 211 which is turn connected via a hub 213 to the nPVR units 203 located at the cable provider's headend facility as described above in connection with FIG. 1.

The user employs a hand-held remote control device 215 to transmit commands to the set top box 207 which are relayed upstream through the cable system hub 208 to the headend processor 205 which controls the reading, writing and formatting of video program content delivered by each of the nPVR units 205. This formatting includes the production of metadata based images and sounds which are combined with the video content data. For example, the added metadata-based information includes channel and segment guide displays, and other information described in more detail below. The headend processor 205 develops these programming aids and controls based on metadata in the metadata store 222, some of which is received as indicated at 224 from metadata supplier (seen at 180 in FIG. 1) which is supplied on a slightly delayed basis to describe the programs, and individual segments of the programs, being delivered by the program content sources 201.

As an example, while the user is watching a program from a selected one of the sources 201 under the control of a particular nPVR unit at 203 that supervises the delivery of that program to the user, the processor 222 may modify the display sent to the television 206 to include a segment guide, an on-screen display that describes the content of segments of the program stored in the selected nPVR. This segment guide uses segment description data from the metadata store 222 that has been received from the metadata supplier 224. When the user wishes to watch a particular segment shown on the displayed segment guide, the remote control unit is employed to highlight and then select a particular segment on the displayed segment guide. When the segment select command is sent from the remote control 215 and relayed by the set top box 207 to the processor 205, the reading address of the active nPVR is changed so that playback continues at the newly selected segment.

Simultaneous Program Viewing functions and features can also be implemented using video storage buffers of the kind employed in personal video recording (PVR) devices located at the subscriber premises as illustrated by the arrangement shown in FIG. 3. A more detailed description of the manner in which video program content and descriptive metadata may be transferred from content and metadata providers to control the presentation provided by a personal video recorder (PVR) at the subscriber's location, and/or to a networked personal video recorder (nPVR) may be found in U.S. Patent Application Publication No. 2003/0093790 published on May 15, 2003.

FIG. 3 illustrates a satellite receiver set top box shown within the dotted rectangle 310 includes four separate channel tuners, indicated generally at 312, each of which can select a different channel received from via the satellite antenna seen at 315. A control processor 320 in the set top box 310 receives selection signals from a hand held remote control unit 330 operated by the user to select particular channels, and applies selection signals to each of the four tuners 312. Thus, up to four different satellite channels can be selected by the processor 320 and received simultaneously. The program content of each of the four channels received by the tuners 312 is stored in a buffer storage area which may exist, for example, on one or more hard disk memory units. The processor 320 controls the writing of program data from each tuner into the buffer storage area, and also controls the reading of that data from the buffer so that, if the channel is currently being viewed, it can be combined with metadata based graphically displayed information at 340 and delivered to a connected television set 350 where it displayed to the user. The metadata which is used to display channel and segment guide information, as well as other metadata based information, is delivered to the set top box from the satellite provider via antennal 315. The metadata for each channel may be provided with the content signal selected by each tuner and then placed in metadata storage as shown at 370 from which it may be utilized by the processor 320 to generate metadata based displays along with the media content signals.

The satellite system implementation of the Simultaneous Viewing System operates, from a viewer's perspective, in essentially the same way that the cable network system of FIG. 2 operates, with the exception that the time-shifting video memory is implemented in the set top box rather than at the headend as in the cable system. Satellite systems employ channels that must be shared by all users and hence, unlike cable systems, do not have the ability to provide a “personalized” signal to each subscriber. Moreover, due to the time delay which a satellite signal experiences in transit from a ground station video server to the satellite and down again to the subscriber location, the turn-around time would prohibit rapid interaction between the commands issued by the user and the response by the distant server. For both of these reasons, it is accordingly desirable to store the channels which make up the SPV session in local storage at the subscriber location in the same way that satellite systems now use local storage to provide SVOD (satellite video on demand) services by storing content broadcast earlier via the satellite at the subscriber location from which it may be viewed, paused rewound, skipped, etc. under the control of the user. Although the satellite SPV system of FIG. 3 is implemented by one or more mass storage devices within the set top box, it will be understood that the same result can be achieved by using a separate personal video recorder (PVR) provided with multiple tuners to simultaneously receive the multiple channels to be viewed in an SPV session. Note also that, if the SPV system is used to simultaneously view programs broadcast at different times, only one tuner may be required. It should also be noted a set top box or standalone PVR may be used with a cable source as well as a satellite source to provide the same functionality.

The Viewer Interface

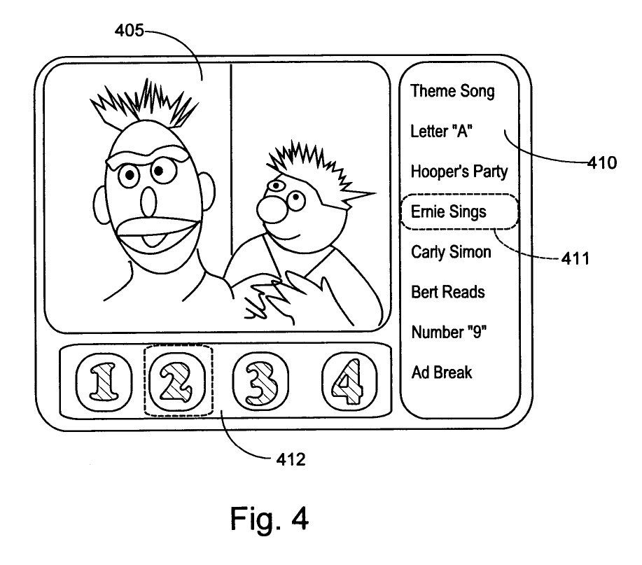

The interface presented to the viewer on the television set display may take the form of a composite image derived from said media content data stored in one or more video buffers, program description metadata, and segment description metadata. The composite image may take the illustrative form shown in FIG. 4 and includes:

(1) a content zone 405 that displays the media content data from a currently displayed segment of a first video programs;

(2) a segment guide zone 410 comprising a set of segment descriptors such as the “Ernie Sings” descriptor seen at 411, each of which identifies and describes an individual segment in the program currently being watched; and

(3) a program guide zone 412 comprising a set of program descriptors each of which identifies an individual one of the video programs available to the SPV session.

As noted below, the segment and program descriptors may each take a variety of forms, including text “labels” as shown at 410. The program and segment guides may transparently overlay the content of the normal programming whenever a “segment guide” button is pressed on the remote control unit, or selected from a menu of other options. Alternatively, when the program and segment guide is requested, the portion of the display showing content is shrunk as shown at 405 in FIG. 4, providing a segment guide zone at the right for an index list of segment labels at 410 and an program guide zone at 412 below the content window 405.

The segment guide or “index” displayed is normally a subset of the total playlist for a given program (“show”) which includes the label or “bookmark” for the segment currently playing. The segment as shown at 410 forms a vertical list of the program's segments displayed on the left or right side of the video image, with the beginning segments at the top, and provides an easily understood guide to the content of the program currently being viewed. When the segment index is displayed, the currently playing segment is highlighted as shown at 411 in FIG. 4. The index can be easily taken off the screen with a click of the remote control (using a “segment guide” button or the like to toggle the guide ON and OFF).

The segment guide typically comprises a list of “slugs,” brief two to five word long descriptions of each segment. In general, the length of slugs will be relatively short. When a high resolution screen is available, the viewer may be offered the option of displaying more detailed text descriptions. Regardless of screen size, at times even short descriptions could trail off the screen, but the view may use the cursor buttons on the remote to scroll the text of the index sideways. Alternatively, a wider horizontal space may be provided to display the descriptive text for the currently selected segment (“selected” meaning either the segment label (called a “slug”) that describes the segment that is playing or a different one being “pointed” to in response to the viewer's movement of the highlighting using the remote's UP and Down cursor buttons). This wider text for a selected label in the index listing could be the same as, or different from, the information shown in the information pane 412 for the highlighted segment as the highlighting changes.

In the display shown in FIG. 4, the program content zone 406 which displays the video picture is shrunk to provide an empty area for the segment guide 410 on one side of the screen, and results in extra space in the vertical dimension that is used for the program guide 412 which includes a set of program descriptors. In the example seen in FIG. 4, four different programs are available in the Simultaneous Program Viewing session, and these four programs are identified by the numerals 1 through 4 which appear as graphical “buttons” which the user may highlight and select in the same way that individual segments are highlighted and selected in the segment guide. Thus, as shown in FIG. 4, it is apparent to the viewer that the “Ernie Sings” segment of Program “2” is currently being viewed.

Applications

Simultaneous program viewing can be applied to advantage in presenting a number of sports events which are presented live at the same time on different channels. For instance, The Sunday Ticket is a simulcast on DirectTV of all the NFL games played each Sunday received by 1.5 million viewers paying $169 per season for the service. Subscribers switch from channel to channel each Sunday afternoon to watch several games that may be on at the same time. Simultaneous Program Viewing in accordance with the invention allows viewers to experience several games, and retain the suspense of live action. Viewers can switch between games, and surf time wise to view the highlights of each game while skipping periods that are not of interest. When attention is switched to another game, the game formerly watched is automatically “paused”—(saved in buffer storage so that, when the viewer returns to that game, he can pick up the action at the point without missing anything. After returning to the time-shifted channel, viewers can use the metadata segment guide to see just the highlights, and hence speed up the viewing of the game, and thus “catch up” to the live broadcast.

In the discussion which follows, frequent reference will be made to the application of SPV features and functions to sports programs. It should be understood, of course, that the features of SPV are not limited to sports event programming.

With SPV, viewers will have the luxury of watching multiple games “at the same time” without missing any important material and spending just the right amount of time on each game. The final result will be known, not at exactly the moment that it happens, but close enough in most cases such that it retains the suspense of a live broadcast.

The SPV system, if used for simultaneous sports events distributed on a cable television system of the type shown in FIG. 1, might be implemented as follows:

All of the games would be served off of nPVR servers at the head-end or hub,

Each game would be supplied with a “segment guide” which can be so that the game, a guide to highlights and other segments in the nPVR buffer, and graphics enabling the user to conveniently switch to another game, would be visible on the screen;

The metadata supplier 180 would generate segmentation data and indexing in close-to-real-time. Preferably, viewers would watch all of the games on a slightly time-shifted basis so that a minimum of metadata could be displayed with the video. Additional metadata could be developed over a longer period of time. For instance, play segmentation could be produced first in almost real-time, cumulative player statistics would be developed after a bit more time had elapsed, while other metadata, such as viewer poll results or the designation of a “play of the game”, would continue to be added over time. Viewers could watch any game live or on a delayed basis, using the nPVR controls such as pause, rewind, forward and reverse slow motion, jump to a segment described on the segment guide;. The longer the viewer was willing to delay viewing a particular game, the more metadata might be associated with it. (In contrast to live broadcasts where only data that can be developed very quickly and inserted into the flow of the broadcast and the context of current play, can be used.)

In addition to the normal metadata functions performed at the headend and on client boxes to implement time wise navigation within the context of a single channel (game), additional functions would be required. The system would, for example store “return bookmark” for each channel for each viewer, so that the viewer could return to any channel formerly viewed and resume watching at the same position.

In addition, the headend should accept option selections from each viewer to modify or personalize screen layout, remove on-screen graphics, display custom information in display areas, and the like.

To facilitate informed switching between channels (games), instead on graphical elements like the numbers seen at 412 in FIG. 4, the viewer could be presented with an on-screen mosaic of images, one image for each channel that is part of the SPV session, which acts as channel guide to assist the user in more intelligently switching from one channel to another within an SPV session. For example, if there were nine different games that the user was monitoring, nine reduced-size images could be shown on the screen in a 3×3 grid. If more channels were part of the session (and in the mosaic) than could be properly shown on-screen, then the mosaic might be horizontally and/or vertically scrollable so that more images that represent channels could be shown.

Each image that represents a channel could be a static screenshot of the channel being monitored, the image being captured at the pause-point (that is, the last image that was seen by the user), or could be a current, pseudo-live view of the channel, or could be a graphic representation identifying the game, such as the combined logos of the two competing teams. For a pseudo live view, the set-top box or a headend server could construct a current, pseudo-live channel representation by periodically sampling the channels in the session, grabbing a screenshot from each. In this way, the screenshots could be refreshed every few seconds and would provide an indication to the viewer when play is resumed after a break in the action.

Overall, this lets the user get a fast, graphical view of the multi-program session. When the user wants to get to watch one of the channels in the mosaic, they could highlight and select (click-through) the image. This would make the mosaic disappear, and the set-top box would tune to the recorded channel, making it full screen video and audio. Note that the mosaic may be displayed at all times, with the active channel being shown in a size-reduced format. Alternatively, the mosaic or other multi channel guide could be shown on a separate “selection menu” screen which could be displayed at any time to get an overview of all the games.

Additionally, in the mosaic view, the user could see a variety of supplementary information. Examples of such supplemental information include:

An indication of long the live broadcast of each channel has been paused. paused. Such an indication could take the form of different colors surrounding the individual mosaic image, for example, red means very far behind (e.g., over 30 minutes) and green means very close (e.g., within 3 minutes); numerical delay times could be shown in or near the image; a “time bar” in or near the image whose length indicates the total time in the buffer and a mark on the time bar indicates the current position of the viewing point; or a clock graphic could be displayed indicating the number of minutes the viewing point has fallen behind real time.

Alternatively, or in addition to the mosaic of images, the user could be presented with an on-screen list of channels in the SPV session. As opposed to the mosaic images described above, this could be a simple list of channels by name (e.g. “ESPN 1”) or by program name (e.g. “Patriots v. Jets”). All of the same supplementary information described above could be applied to the channel list instead of to or in addition the channel images.

The channels as listed could be color-coded (either the text itself, or a box in which the text sits) so that the user could easily remember and identify the different channels (e.g., the blue text or blue box in the Patriots v Titans game). This would be especially useful in the case of dynamic channel line-up lists (see below) where the channels constantly change, since recognizing a color is faster than reading the title of the channel or the content within that channel. As an alternative to colors, the channels in the channel list could be represented by icons (e.g., team graphics or logos), pictures, numbers, or some other graphical image.

The user could use remote control number buttons to switch between channels in the SPV session. For example, if there are 5 channels part of the SPV session, the user could press #2 and be switched to the 2nd channel in the session lineup; remote control button #3 takes them to the 3rd channel; etc. This is a time-saving feature that allows users to press just one button instead of the normal three digit number used in digital cable and satellite TV channel maps. To give special significance to the channel buttons, a special mode (e.g., “SPV mode”) would have to be enabled so that button presses were recognized to mean that the set-top should switch to an SPV channel, and not a regular linear channel. Enabling this special mode could be accomplished by simultaneously pressing another key along with the number button, preceding the number button with a different key, holding down the number button for a long duration (e.g., over 1 or 2 seconds), or some other mechanism.

The lineup of channels in the SPV session could be static or dynamic. In the case of static channel line-ups, whatever order was created when a session was first created and/or programmed would remain the same order for channel navigation throughout the viewing session, or until the user manually changed the order based on their preference. In a dynamic lineup scenario, the channels would be arranged based on an algorithm that took into account one or more characteristics of the channels (e.g., time paused behind the live broadcast, what had transpired in the recordings after the pause-point, popularity of the channel with other viewers, what content was being shown, etc.)

As an alternative to using number buttons, the user could change SPV session channels by pressing “channel up” and “channel down” on the remote control, thereby surfing incrementally through the lineup (be it a static or dynamic lineup).

The system could display transition interstitials (e.g., graphics, color, audio, and/or video) when a user switches between SPV session channels. These interstitials would serve to add context to the viewing experience, so that the user has an indication of the channel being switched to, and/or channel being switched from. For example, the user could see a 1 second video of a New England Patriots player rushing from one side of the screen to the other, shown right before they are switched to the New England Patriots game on one of the SPV session channels.

Alternatively or in additionally, the interstitial might provide context to indicate how far back in time the user is going when tuning to different SPV session channel. The user might see a clock image or number of minutes or some other graphic or video to indicate that they are stepping back in time by tuning to a channel. For example, a big “5 minutes” might flash between SPV session channel switches, indicating that the viewer is picking up the game 5 minutes post-live-broadcast-time. The time indicated by this interstitial might be related to how far behind game-clock-time the paused channel is, how far behind live-broadcast-time the channel is, or how far in the past or future the user is jumping from the SPV session channel that they are currently watching.

Additionally, an interstitial might be displayed when performing time-wise jumps within one particular SPV session channel. For example, as the user jumps forward in time within a time-shifted recording to the next index point (e.g. the next segment bookmarked by metadata), the user could be shown an interstitial (e.g., graphics, color, audio, and/or video) that indicates how far in time they are jumping forward. The time in question could be game-clock-time, broadcast-clock-time, or percentage-of-asset being viewed.

Interstitial displays of this type may be used with both manual browsing (that is, clicking on index segments in the stream guide or clicking the “next segment” button) as well as automatic browsing (using a “push” model described below). However, the latter automatic browsing case would benefit more from the addition of the interstitial, since the user is not the one causing the jump (in time, or in content/channel), and therefore more likely to be lost without the context supplied by the interstitial.

The channels which participate in a SPV session may be specified by the MSO, a content provider, or the metadata supplier, any of which could organize a set of related channels. In addition, an individual may select a set of channels to be watched using SPV. The user or the operator could set the order of channel rotation. The system could also dynamically set the channel order by discerning which channels are of most interest [by minutes viewed or number of times accessed] and putting the related channels at the top of the stack. Channels not selected for viewing would automatically be paused with a bookmark being established at the point of departure.

When the viewer returned to the channel that had been paused, the most logical place to return to would be the point at which the program was paused. Other options for the where the viewer could return to include:

The beginning of the paused program;

The point of live broadcast;

The last un-viewed highlight;

The last un-viewed “hotspot” (as determined viewing choices made by other subscribers).

The last unviewed segment of a type which the user prefers, as determined by an express choice from the viewer, or a determined by an analysis of the viewers prior segment selections; or

A segment selected based on the length of time the user has left a channel in a paused condition; for example, if a long time had elapsed, the viewer might be taken to the beginning segment in a highlight playlist.

When a viewer turns the TV off, or switches to a channel outside the block of SPV channels, the bookmarks denoting where viewing was terminated for each game would be saved. This would allow the viewer to come back later and pick up where viewing left off.

At some point the viewer might be required to erase the bookmarks to start a new “session” (presumably the next week in the case of football). Alternatively, this erasure might be done automatically, or the video and bookmarks could be saved indefinitely on the storage means.

Alerts and Information for Channel Switching

The video screen would be divided into sections (for example, a program viewing area reduced in size to make room for navigation index (e.g. a segment guide containing a list of segment descriptions or a mosaic of segment images), an alternate channel selection area containing a channel guide consisting of a list of channel descriptions or a mosaic of channel images, and ad banner area (for advertising supported SPV sessions). Users could configure the alternate channel selection area to monitor other games of interest while watching their game of primary interest by displaying information about the subsidiary games in these other screen areas. For other games, viewers would have the option of:

A. Not displaying any information if the game is of no interest

B. Having other game scores displayed in real time

C. “Freezing” the score of other games at the point they were last-viewed.

This last strategy would “mask” the score of these games while at the same time remind viewers of what had transpired up until that point.

For the “masked” games, an alert could be displayed if something of note happened. For instance, an alert could be displayed if a player on a viewer's fantasy football team did something of significance. This alert could tell the watcher what happened or simply be a cue to switch channels. Users would have the ability to define, and set the thresholds for, content description metadata which, if the preset conditions were satisfied, would display (or sound) an alert.

Users would be able to set this preference, and others disclosed in this invention, either from a menu display on the TV, cell phone, or from a PC interface.

Furthermore, the alternate channel selection area could display a graphic for each monitored game that symbolized how much or what kind of “action” the viewer was missing on each channel. This could be thought of as a composite of all the alerts to which the viewer had not responded.

The alternate channel selection area could further display graphically, or in text form, information describing the paused channels conveying how far behind real time they had slipped. This time delay could be expressed as minutes-behind-the-broadcast, or minutes-behind-the-game-clock. The combination of time-delay information and alerts posted for other games, would give the viewer information upon which to base a channel switching choices. The viewer could get to alternative games that had posted alerts by clicking on the alert, using the channel rotation toggle described above, by activating a command, or by using another means.

The viewer could reenter the video stream corresponding to the different game in any number of locations. For instance, viewing could begin at the beginning of the play or drive that generated the alert, the last viewed location where the video had been paused, the last highlight, or the point of live broadcast, among others.

Preferably, the landing position would be chosen as a function of how much time the viewer had to watch the rest of the unseen game. If time was not an issue, the restart point might simply be the point at which the show had been previously paused. If time was an issue, the pickup point might be the beginning of a playlist of highlights starting at the paused location, or even a short list of highlights that started later and focused on the drive or play that instigated the alert.

In any case, the channel and segment guides would not display any information for plays the viewer had not yet seen unless expressly requested by the user. For sports events, to retain the suspense, while the viewer could skip forward at a high rate of speed by jumping from highlight to highlight, no “preview” would be permitted until a viewer had watched that game to its conclusion. After that occurs, the viewer would be given access to a full index of the highlights, including an identification of the plays in which “scores” occurred, to more easily review the history of the game.

Another type of alert would be the Stayed Tuned Alert or the “stay in your seat” alert. When watching a time-shifted portion of a game, the system (the automatic or human metadata creators, called “taggers”) would supply metadata describing what was coming up next. Therefore an alert could be displayed that would suggest to the viewer not to change channels because something interesting was about to happen. The benefit of this alert is based on the premise that it is more enjoyable to watch an interesting event as close to real time as possible and to see it without having to switch channels. While the alert feature ensures that good sections of video are eventually watched, this feature serves to minimize channel switching and helps viewers watch longer blocks of continuous action. The viewer could specify the parameters for this alert beforehand. The Stay Tuned Alert could be described in metadata, and appear only if the user tried to change channels.

Preferences could be expressed by the viewer, or inferred by the system, that would specify the degree to which the viewer tolerated falling behind real time across the multiple games being monitored. If the viewer started to fall too far behind, the system could reconstruct new playlists for the unviewed games in order to move the viewer through the games faster once the viewer finally toggled over to these other channels.

This acceleration could be accomplished by reducing the length or number of plays in a highlight playlist. For playlists that presented the whole game (and thus no material is deleted) the segment size could be increased where possible in order to let the viewer take “bigger steps”. Alternatively, the step size could be made smaller to let the viewer more easily pick out those segments worth seeing at that point.

An important feature of the system would be the ability to block out information about other games in progress that might be displayed on the currently being watched game. For example, a broadcast of one game might report the score of another game which the viewer had paused. This information currently is often displayed in a small on-screen graphic. This masking could be applied at all times, or at the request of the viewer. To the extent there was any audio that gave away the progress of another game, would mask that information as well.

PIP (Picture-in-Picture) devices, in which a reduced size image of another channel is displayed in an on-screen window) has never been a popular feature, probably because of the impracticality of trying to watch two things at once. The presentation of material from another channel could, however, be used as an alert system for SPV. A picture-in-picture feature, for instance, would be quite valuable in monitoring multiple games. The segment guide and controls would apply to the main picture that was in “focus” while the minor PIP picture was merely viewed. By toggling focus over to the PIP, however, and clicking, the minor picture would then become the major image with its own attendant stream guide. The navigation buttons on the remote would then control this image. The picture that had been the major picture could then become the minor picture, or it could be put into pause mode for viewing later. This choice could be made automatically or by command at time the switch was made. An alternative method of swapping the positions of the images would be to activate a Make Minor button or command, at which point the current full-video image would become the minor picture. A second button or command could eliminate the PIP if the user wanted to focus on this window. To help viewers better manage the PIP switching process, supplemental information about the subsidiary window could be displayed in a portion of the screen even while the major picture was in focus and occupying the primary viewing real estate. For instance, a part of the segment guide screen area could be devoted to a list of recent plays from the subsidiary game. This index could have past and/or future plays displayed. In either case, the viewer could glance at the playlist from time to time to see if the channel should be switched. Alternatively, perhaps the yard line information in a football game is too small to read in the minor PIP and as a result this information is reformatted and displayed elsewhere on the screen.

Other more specific alerts could be displayed in the alert area related to the subsidiary PIP games as well. Clicking the appropriate command or button would bring into focus and enlarge the subsidiary game at the point where the noted action started. Alternatively, the viewer would have to navigate to that starting point.

Because the time shifting of each window can be controlled independently, a time indicator may be displayed on screen for the subsidiary window.

A Push Version

For those viewers not interested in actively controlling their display, a “push” mode of operation may be requested by the user. When operating in the push mode, the SPV system would automatically switch games in accordance with a pre-selected playlist.

A push system would be particularly useful to control the operation of a main and a subsidiary display in a PIP presentation. In this implementation, the system would roll highlights from one pre-selected game to another in the subsidiary window. As each game appeared in the PIP window, appropriate information would be displayed on the screen to supply information about the current and past plays.

The user could pre-configure (and change the configuration during viewing) for different characteristics or levels of browsing. For example, the user might specify that only a specified amount of time will be available to watch a certain number of channels, and the system then tailors the content and timing of the presentation to stay within the configured time period of viewing. Else, the user might select that they want the system to tune to another SPV session channel only if a particular event has occurred (e.g., scoring play in a football game, hotspot or viewing popularity of a certain level).

Also, the user might configure the system to have different types of playlists automatically played (pushed) on different channels. For example, if the user has several football games in their SPV session, but one team is their home-team, the user will likely want to spend more time on that one game than the rest. In a manual browsing mode, this is easily accomplished by the user sticking to that one channel. In automatic mode (push) this channel preference needs to be configured into the system, so that the system spends more time on that one channel (for example, 10 minutes average whereas other channels get 5 minutes, or a setting for 5 times the amount of time over other channels, etc.), or plays a different playlist on that channel (e.g., shows a Condensed Game playlist or uses a Condensed Game index, as opposed to a Highlights playlist or index used on other lesser-important channels).

When operating in push mode, the SPV session channel switching algorithm and playlist/index events may be governed not by what the user wishes to see (e.g., scoring plays, etc.), but by a specification of what the user doesn't want to see (e.g., timeouts, commercials, etc.). In this case, the SPV push control would automatically switch the channel or jump to the next tag within a channel/stream when something happens in the content that the user has elected not to view. For example, a user could specify that commercials are not to be shown. When the system is about to show the user a commercial and senses this (either because there is tagging or other metadata that marks the upcoming content as a commercial, or some other mechanism is used such as digital cue tones), then the system automatically switches to another SPV session channel, or jumps ahead within the selected channel to the next permitted segment. The user could also configure if they wanted to automatically switch back when the offending event (e.g., commercial) was over, or whether instead they wanted to remain on the channel to which they were automatically switched.

The SPV concept could apply to other sports events beside football. Baseball, basketball, hockey and college football are all sports where multiple games are often broadcast at the same time.

Another major application is news where multiple channels are covering the day's news at the same time. A simple SPV system would be very useful for news watching allowing viewers to roll from channel to channel, skimming through an index of stories and thus allowing a viewer to consume multiple news channels at “the same time”. Unlike sports examples, SPV for news involves multiple channels covering largely the same body of content. Thus a major added feature of SPV for news would be the ability to tag stories that are duplicates of stories already viewed by the user. Using metadata which identifies topics, the SPV system could either avoid presenting the user with redundant content. The system could delete redundant stories from the playlists of channels yet to be viewed based on the fact that the viewer had seen or skipped through such stories on previous channels. Alternatively, the system could take the opposite approach and offer the viewer the option of navigating to other redundant stories, on other channels, that covered the same topic. (This idea is based on the thought that there are rarely two stories that are totally redundant and that someone really interested in the topic might wish to see several perspectives on the same story.) The viewer could also indicate to the system via some mechanism, how much time was available to peruse all the channels to be viewed. With this information, the system could automatically tighten up its definition of “redundant” to reduce the size of each channel's playlist. Furthermore, viewers could implicitly or explicitly input topics of interest. With this information, the system could further tighten up its playlists to stay within a specified time budget by dropping less important stories from its playlist. The system could also employ information describing a user's interests and preferences, such as user-specified list of the user's favorite channels. With this information, the system would steer the viewer to this favorite channel by selectively keeping stories that have redundant copies on other channels in the playlists of favorite stations, while marking similar stories on other channels as redundant.

While watching related programs of the same kind (e.g. a group of football games) at the same time will often be desirable, the programs may be unrelated. The system is potentially applicable to any set of shows whether broadcast in real time at the same time, or programs broadcast at different times. As long as the programs are available for controlled playback from a nPVR. PVR, a VOD server, or other storage device, they may be viewed simultaneously using SPV techniques. The SPV capability allows the user to pause multiple channels at once, choose a desired channel using a metadata-based channel guide, skim through the stored content for each channel with a metadata-based segment guide, and go back to old channels at the point where the viewer left off. The system should thus include the ability to store the point-of-pause bookmarks for multiple shows for a prescribed period of time.

Conclusion

It is to be understood that the methods and apparatus which have been described above are merely illustrative applications of the principles of the invention. Numerous modifications may be made by those skilled in the art without departing from the true spirit and scope of the invention.

What is claimed is:

1. A method comprising, in combination, the steps of:
storing media content data for two or more different video programs,
storing program description metadata which identifies and describes each of said video programs,
storing segment description metadata which identifies and describes segments of each of said video programs,
displaying on a visual display device a composite image derived from said media content data, from said program description metadata, and from said segment description metadata, said composite image consisting of:
a content zone displaying a video image from a currently displayed segment of a first of said video programs,
a program guide zone displaying a set of program descriptors each of which identifies an individual one of said different video programs, and
a segment guide zone comprising a set of segment descriptors each of which identifies an individual segment of said first of said video programs,
employing a user interface device for accepting selection commands from said viewer,
accepting a segment selection command from said user interface device designating a selected segment identified by one of said segment descriptors,
displaying said selected segment as the currently displayed segment in said composite image,
accepting a program selection signal from said user interface device designating a selected program identified by one of said program identifiers, and
in response to said program selection signal, displaying a set of segment descriptors each of which identifies an individual segment of said selected program in said segment guide zone and displaying an initial one of the segments of said selected program in said content zone.

2. A method as set forth in claim 1 wherein each of said program descriptors in said program guide zone is reduced size image extracted from the media content data for one of said video programs.

3. A method as set forth in claim 2 wherein each of said segment descriptors in said program guide zone is a text description of the content of the individual segment identified by said descriptor.

4. A method as set forth in claim 1 wherein each of said program descriptors in said program guide zone is a graphical symbol indicative of one of said video programs.

5. A method as set forth in claim 4 wherein each of said segment descriptors in said program guide zone is a text description of the content of the individual segment identified by said descriptor.

6. A method as set forth in claim 1 wherein each of said segment descriptors in said program guide zone is a text description of the content of the individual segment identified by said descriptor.

7. A method as set forth in claim 1 further including the step of visually identifying on said composite image that segment identifier which identifies said currently displayed segment.

8. A method as set forth in claim 1 wherein said set of segment descriptors is visually organized in an ordered sequence which corresponds to the sequence in which the segments identified by said set occur within a given one of said video programs.

9. A method as set forth in claim 8 further including the step of automatically and sequentially presenting the video image from the segments identified by said set in said content zone.

10. A method as set forth in claim 1 wherein said two or more different video programs are live productions of two or more different events as they occur.

11. A method as set forth in claim 10 wherein said step of storing media content data comprises the step of storing said media content data as it is produced and wherein said segment description metadata identifies segments of each of said video programs previously stored at different times.

12. A method as set forth in claim 11 wherein said segment description data is produced after the occurrence of said live events but before the step of displaying said live event.
